(19) United States
(12) Patent Application Publication
(10) Pub. No.: US 2026/0243387 A1
(43) Pub. Date: Aug. 20, 2026

(54) A DISPLAY MOUNTING APPARATUS

(71) Applicant: Ergotron, Inc., St. Paul, MN (US)

(72) Inventor: Christopher Eric Naujok, Hudson, WI (US)

(21) Appl. No.: 19/474,660

(22) PCT Filed: May 1, 2024
(86) PCT No.: PCT/US2024/027229

§ 371 Date: Oct. 10, 2025

Related U.S. Application Data
(60) Provisional application No. 63/463,764, filed on May 3, 2023.

(51) Int. Cl. F16M 11/04; F16M 11/10; F16M 11/24; F16M 13/02

(52) U.S. Cl. CPC F16M 11/041; F16M 11/10; F16M 11/242; F16M 13/022; F16M 2200/024

(57) ABSTRACT

A display mounting apparatus can include a work surface, a stand assembly, a clamp assembly, and a belt assembly. The stand assembly can be configured to hold an electronic display over the work surface. The clamp assembly can be coupled to the work surface. The belt assembly can be coupled to the stand assembly and the clamp assembly. The belt assembly can define a length that is adjustable to adjust a position of the stand assembly relative to the claim.

### CLAIM OF PRIORITY

This patent application claims the benefit of priority of Naujok, U.S. Provisional Patent Application Ser. No. 63/463,764, entitled “A DISPLAY MOUNTING APPARATUS,” filed on May 3, 2023 (Attorney Docket No 5983.480PRV), which is hereby incorporated by reference herein in its entirety.

### TECHNICAL FIELD

This document pertains generally, but not by way of limitation, to devices that can hold an electronic display above a work surface.

### BACKGROUND

Mounting devices for electronic displays (e.g., flat panel displays, tablets, or the like) are commonly used for various purposes. For example, a display mounting apparatus can be used to position one or more electronic devices above a work surface (e.g., a table, a work surface of a mobile workstation, or the like). The display mounting apparatus can provide some articulation for the one or more electronic displays to change their orientation (e.g., change the tilt angle, rotation, distance, or the height) relative to a user.

### BRIEF DESCRIPTION OF THE DRAWINGS

The following drawings are illustrative of particular embodiments of the present invention and therefore do not limit the scope of the invention. The drawings are not to scale and are intended for use in conjunction with the explanations in the following detailed description. Like numerals may describe similar components in different views. Like numerals having different letter suffixes may represent different instances of similar components. The drawings illustrate generally, by way of example, but not by way of limitation, various embodiments discussed in the present document.

FIG. 1 is a rear perspective view of a display mounting apparatus according to an example configuration of the current disclosure.

FIG. 2 is a side view of the display mounting apparatus of FIG. 1 at a reclined configuration as positioned over a work surface.

FIG. 3 is a side view of the display mounting apparatus of FIG. 1 positioned over a work surface.

FIG. 4 is a perspective view of a display interface according to an example configuration of the current disclosure.

FIG. 5 is a rear perspective view of an electronic display with the display interface of FIG. 4 coupled to the housing of the electronic display.

FIG. 6 is a perspective view of the stand assembly of FIG. 3.

FIG. 7 is an exploded view of the stand assembly of FIG. 6.

### OVERVIEW

This disclosure is directed to a display mounting apparatus. The display mounting apparatus can include a stand assembly, a clamp assembly, and a belt assembly. An electronic display can be coupled to the stand assembly. The stand assembly can be used to change an orientation of the electronic display.

The display mounting apparatus can be located over a work surface to position the electronic display above the work surface. The stand assembly can be releasably coupled to the clamp assembly via the belt assembly. The user of the display mounting apparatus can selectively change the position of the stand assembly relative to the clamp assembly.

The stand assembly can include one or more legs. The one or more legs can move (e.g., rotate, translate, pan, or the like) to provide some articulation for the electronic display coupled to the display mounting apparatus. The clamp assembly can be coupled to the work surface, and the stand assembly can be moved towards or away from the clamp assembly by adjusting a length of the belt assembly.

The above discussion is intended to provide an overview of subject matter of the present patent application. It is not intended to provide an exclusive or exhaustive explanation of the invention. The description below is included to provide further information about the present patent application.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

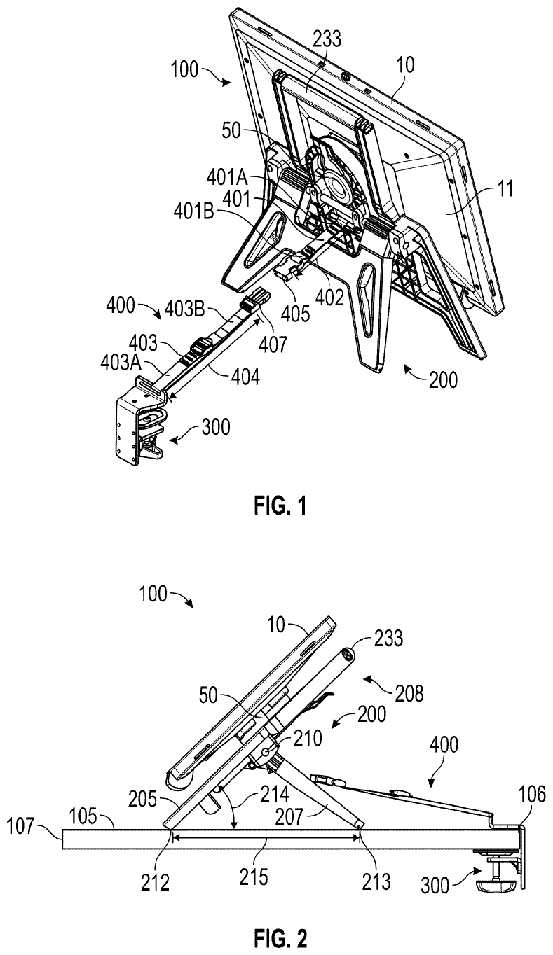

FIG. 1 is a rear perspective view of a display mounting apparatus 100 according to an example configuration of the current disclosure. The display mounting apparatus 100 can include a stand assembly 200, a clamp assembly 300, and a belt assembly 400. An electronic display 10 can be coupled to the stand assembly 200 via a display interface 50. The display mounting apparatus 100 can be configured to hold the electronic display 10 over a work surface 105, such that the display mounting apparatus 100 is supported by, or rests on top of, the work surface 105.

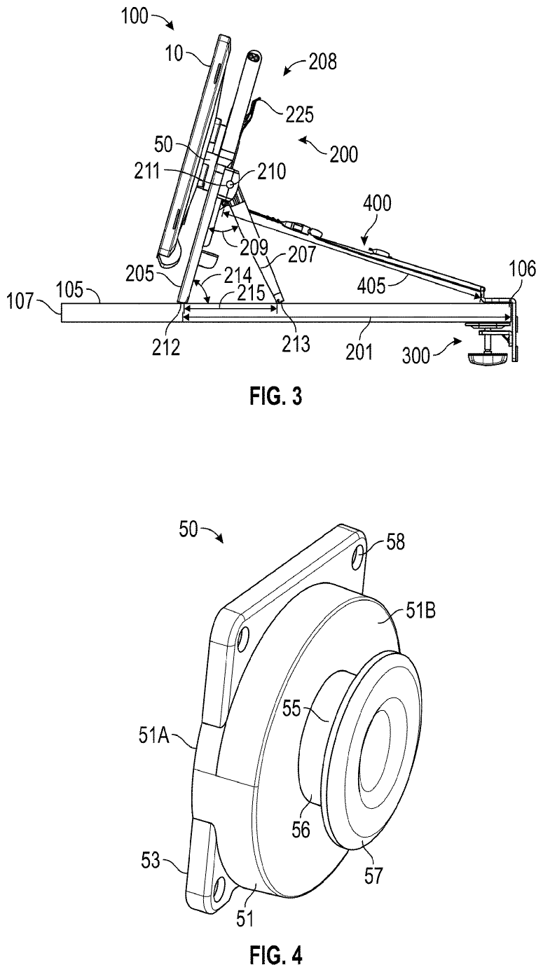

FIGS. 2-3 are side views of the display mounting apparatus 100 of FIG. 1 at two different configurations of the stand assembly 200. The clamp assembly 300 can be coupled to an edge (e.g., coupled to a rear edge 106 opposite the front edge 107) of the work surface 105. The stand assembly 200 can be positioned away from the clamp assembly 300 (e.g., located closer to a user of the electronic display 10 positioned proximate the front edge 107 of the work surface 105). The belt assembly 400 can be coupled between the stand assembly 200 and the clamp assembly 300 to keep the display mounting apparatus 100 over the work surface 105.

In some example configurations, the belt assembly 400 can include a first portion 401 having a first length 402, and a second portion 403 having a second length 404 (shown in FIG. 1). The first portion 401 of the belt assembly 400 can include a first end 401 A and a second end 401B opposite the first end 401A. The second end 401B can be spaced apart from the first end 401A to define the first length 402 of the first portion 401. The first end 401A of the first portion 401 can be coupled to the stand assembly 200 and a first clip 406 can be coupled to the second end 401B of the first portion 401.

The second portion 403 of the belt assembly 400 can include a first end 403A and a second end 403B opposite the first end 403A. The second end 403B can be spaced apart from the first end 403A to define the second length 404 of the second portion 403. The first end 403A of the second portion 403 can be coupled to the clamp assembly 300 and a second clip 407 can be coupled to the second end 403B of the second portion 403.

In an example configuration, the first clip 406 can be removably coupled to the second clip 407 to form the belt assembly 400, and thereby, the first length 402 and the second length 404 together can define a length 405 (shown in FIG. 3) of the belt assembly 400. In other example configurations, the belt assembly 400 can be made in a single portion coupled between the stand assembly 200 and the clamp assembly 300. The first portion 401 and the second portion 403 of the belt assembly 400 can be made of fabric, plastic, metal straps, or the like. Though the belt assembly 400 is discussed as being a belt, the belt assembly can be any other flexible or rigid connector such as a cord, chain, rod, bar, or the like. The belt assembly 400 can have an adjustable length to position the stand assembly 200 at a desired distance 201 (shown in FIG. 3) from the clamp assembly 300 over the work surface 105.

In some example configurations, the stand assembly 200 can include a stand body 205, one or more legs 207 and a handle assembly 208. The one or more legs 207 can be rotatably coupled to the stand body 205 at a first hinge 210 having a first hinge axis 211, and the handle assembly 208 can be coupled to the stand body. The stand body 205 can form one or more first contact points 212 with the work surface 105, and the one or more legs 207 can form one or more second contact points 213 with the work surface 105. The work surface 105 can support the stand assembly 200 through the first contact points 212 and the second contact points 213 as illustrated in FIGS. 2-3. An inclination angle 214 can be formed between the stand body 205 and the work surface 105 as the display mounting apparatus 100 is located over the work surface 105.

The one or more legs 207 can rotate relative to the stand body 205 about the first hinge axis 211 to adjust a distance 215 between the one or more first contact points 212 and the one or more second contact points 213. As the distance 215 increases, the stand body 205 can recline towards the work surface 105 (i.e., the inclination angle 214 can decrease as illustrated in FIG. 1), and thereby, changing an inclination angle of the electronic display 10 relative to the work surface 105.

FIG. 4 is a perspective view of the display interface 50 of FIG. 1 according to an example configuration of the current disclosure. The display interface 50 can include an interface body 51 having a first portion 51A and a second portion 51B. A flange 53 having one or more apertures 58 can be built proximate the first portion 51A and a boss 55 can be formed on the second portion 51B. The boss 55 can extend from the second portion 51B of the interface body 51 in a transverse direction and a rim 57 can be formed on the boss 55 away from the second portion 51B of the interface body 51. The boss 55 and the rim 57 can be formed in any cross-section (e.g., round, square, or the like). The boss 55 can have a smaller cross-section compared to the rim 57, and thereby, a recessed section 56 can be formed between the second portion 51B of the interface body 51 and the rim 57.

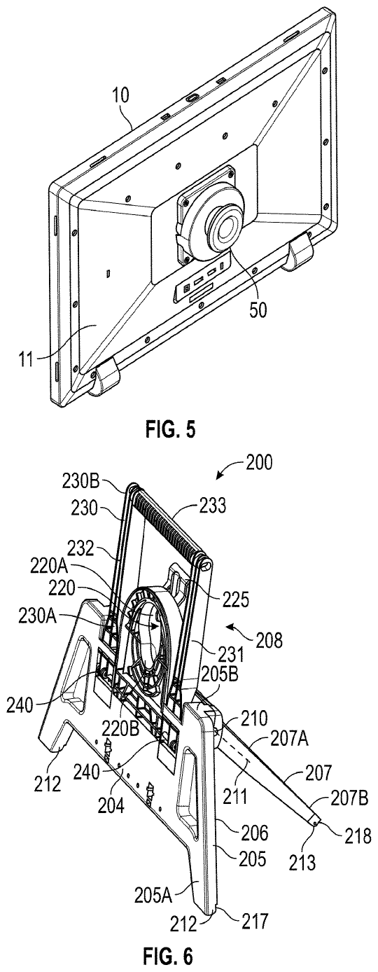

FIG. 5 is a rear perspective view of the electronic display 10 of FIG. 1. The display interface 50 can be coupled to a rear housing 11 of the electronic display 10. The first portion 51A of the interface body 51 (shown in FIG. 4) can face the rear housing 11. One or more mechanical fasteners (e.g., one or more screws) can be inserted through the one or more apertures 58 of the display interface 50 and engage with the rear housing 11 to fasten the display interface 50 to the electronic display 10. The display interface 50 can be removably coupled to the stand assembly 200 to hold the display over the work surface 105.

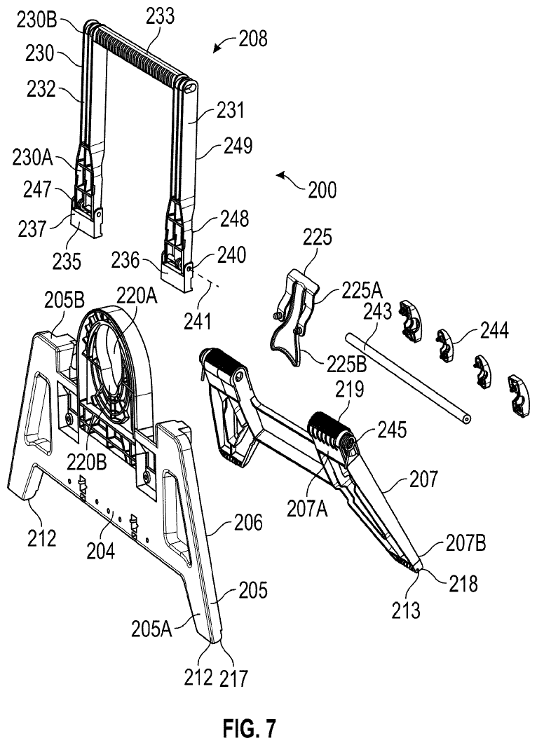

FIGS. 6-7 are a perspective view and an exploded view of the stand assembly 200 of FIG. 1, respectively, according to an example configuration of the current disclosure. FIGS. 6-7 are discussed together below.

The stand assembly 200 can include a stand body 205 extending from a first portion 205A to a second portion 205B. The stand body 205 can have a thickness between a front face 204 and a rear face 206. In some example configurations, the stand body 205 can include one or more first feet 217 proximate the first portion 205A. The one or more first feet 217 can be configured to rest on the work surface 105, and the one or more first feet 217 can form one or more first contact points 212 with the work surface 105.

The stand body 205 can also include an opening 220 proximate the second portion 205B. The opening 220 can include a first section 220A and a second section 220B. The first section 220A can be larger than the second section 220B. The first section 220A and the second section 220B can intersect to form the opening 220 that extends at least partially through the stand body 205. The first section 220A and the second section 220B can be in any shape (e.g., round, rectangular, elliptical, or the like). In some example configurations, the second section 220B can be located below the first section 220A. The first section 220A can be adapted to receive the rim 57 of the display interface 50 therethrough for positioning of the display interface into the opening 220. The second section 220B can be adapted to receive the boss 55 of the display interface 50 following receipt of the boss 55 and the rim 57 into the first section 220A to help secure the display interface 50 to the stand body 205. An outside contour of the boss 55 (e.g., circular, square, or the like) can at least partially match the contour of the of the second section 220B of the opening 220.

The stand assembly 200 can also include one or more legs 207. The one or more legs 207 can be elongated between a proximal section 207A and a distal section 207B. The one or more legs 207 can be rotatably coupled to the stand body 205 at a first hinge 210 proximate the proximal section 207A of the one or more legs 207. An instantaneous leg angle 209 can be formed between the stand body 205 and the one or more legs 207 at any rotation of the one or more legs 207 relative to the stand body 205.

In some example configurations, the one or more legs 207 can include one or more second feet 218 located at the distal section 207B, and one or more channels 219 can be formed at the proximal section 207A of the one or more legs 207. The one or more channels 219 can be elongated in a direction parallel to the first hinge axis 211. The one or more second feet 218 can be configured to rest on the work surface 105, and the one or more second feet 218 can form one or more second contact points 213 with the work surface 105. The one or more legs 207 can cooperate with the stand body 205 to maintain the display mounting apparatus 100 over the work surface 105.

In some example configurations, the stand assembly 200 can include a retainer 225. The retainer 225 can be coupled to the stand body 205 proximate the second portion 205B. The retainer 225 can include a stationary portion 225 A and a flexible portion 225B. The stationary portion 225A can be coupled to the rear face 206 of the stand body 205 using one or more mechanical fasteners (e.g., one or more screws, rivets, or the like). The flexible portion 225B can have a free state and a compressed state. In the free state, the flexible portion 225B can be stress free and relaxed, as illustrated in FIGS. 6-7. The flexible portion 225B can be pushed away from the rear face 206 of the stand body 205 to put the flexible portion 225B into a compressed state.

The flexible portion 225B can at least partially overlap with the first section 220A of the opening 220 of the stand body 205 in the free state of the flexible portion 225B. The flexible portion 225B can be configured to deflect away from the rear face 206 of the stand body 205 in a compressed state when the rim 57 of the display interface 50 is inserted into the first section 220A of the opening 220.

The rim 57 of the display interface 50 can be inserted into the first section 220A of the opening 220 by deflecting the flexible portion 225B of the retainer 225 away from the rear face 206 of the stand body 205. When the rim 57 is fully inserted into the first section 220A, the boss 55 of the display interface 50 can overlap with the stand body 205 and the rim can be located behind the rear face 206 of the stand body 205. The boss 55 can be at least partially inserted into the second section 220B of the opening 220. A section of the stand body 205 (e.g., a section proximate to the second portion 205B) can be inserted into the recessed section 56 between the second portion 51B of the interface body 51 and the rim 57. In some example configurations (e.g., when the second section 220B of the opening is located below the first section 220A of the opening), the boss 55 can stay inside the second section 220B of the opening 220 at least partially due to gravity.

When the boss 55 is inserted into the second section 220B of the opening 220, the flexible portion 225B of the retainer 225 can rebound towards the second portion 51B of the interface body 51 (e.g., the flexible portion 225B can spring back towards the rear face 206 of the stand body 205) to take form in the free state. In the free state of the flexible portion 225B, the flexible portion 225B can overlap with at least one of the boss 55 or the rim 57 of the display interface 50 and trap the boss 55 inside the second section 220B of the opening 220 to put the display mounting apparatus 100 in a secured configuration. In the secured configuration, the retainer 225 can block the display interface 50 inside the opening 220 of the stand assembly 200. When the user of the display mounting apparatus 100 wants to remove the display interface 50 from the stand assembly 200 (e.g., detach the electronic display 10 from the display mounting apparatus 100), the user of the display mounting apparatus 100 can manually deflect the flexible portion 225B of the retainer 225 (e.g., deflect the flexible portion away from the rear face 206 of the stand body 205) to put the display mounting apparatus 100 in an unsecured configuration. In the unsecured configuration, the user of the display mounting apparatus 100 can move the boss 55 of the display interface 50 from the second section 220B into the first section 220A of the opening 220, and then, the user of the display mounting apparatus 100 can slide the rim 57 towards the front face 204 of the stand body 205 until the display interface 50 disengages from the first section 220A of the opening 220.

In some example configurations, the handle assembly 208 can include one or more arms 230 (e.g., a first arm 231 and a second arm 232, as illustrated in FIG. 6) and a handle 233. The one or more arms 230 can be elongated between a first arm portion 230A and a second arm portion 230B. The second arm portion 230B can be farther away from the work surface 105 compared to the first arm portion 230A. The handle 233 can be coupled proximate the second arm portion 230B, and a connector 235 can be coupled proximate the first arm portion 230A. In some example configurations, the handle 233 can be coupled between the first arm 231 and a second arm 232, as illustrated in FIGS. 6-7.

The one or more arms 230 can be rotatably coupled to the connector 235 at a second hinge 240 having a second hinge axis 241. In some example configurations, the second hinge axis 241 can be parallel to the first hinge axis 211. The connector 235 can be coupled to the stand body 205, and thereby, the handle assembly 208 can be rotatably coupled to the stand body 205 at the second hinge 240. In some example configurations, a first connector 236 and a second connector 237 can be rotatably coupled to the first arm 231 and the second arm 232, respectively. The first connector 236 and the second connector 237 can be coupled to the stand body 205, and thereby, the handle 233 can be rotatably coupled to the stand body 205 at the second hinge 240.

The stand assembly 200 can also include a rod 243. The rod 243 can be an elongated member having a round cross-section at least along a portion of its length. The rod 243 can be made from a material, including but not limited to, steel rod or tube, aluminum rod or tube, nylon rod or tube, or the like. The rod 243 can be inserted through the one or more legs 207 proximate the proximal section 207A of the one or more legs 207 and inserted through the stand body 205 proximate the second portion 205B of the stand body 205 to form the first hinge 210. The rod 243 can be concentric with the first hinge axis 211. The rod 243 can be attached to the stand body 205 via one or more clasps 244.

In some example configurations, the first hinge 210 can include one or more first torsion springs 245. The one or more first torsion springs 245 can be concentric with the rod 243, and the one or more first torsion springs 245 can be coupled between the stand body 205 and the one or more legs 207. The one or more first torsion springs 245 can bias the one or more legs 207 to rotate towards the stand body 205 (e.g., bias the one or more legs towards the stand body to decrease the instantaneous leg angle 209).

In some example configurations, the second hinge 240 can include one or more second torsion springs 247. The one or more second torsion springs 247 can be coupled between the connector 235 and the one or more arms 230. The one or more second torsion springs 247 can bias the one or more arms 230 to rotate away from the rear face 206 of the stand body 205 (e.g., bias the one or more arms 230 to rotate away from the rear housing 11 of the electronic display 10). In some example configurations, the one or more arms 230 can include one or more projections 248. The one or more projections 248 can be formed on an outer surface 249 of the one or more arms 230 facing towards the one or more legs 207, and the one or more projections 248 can extend from the outer surface 249 of the one or more arms 230 in a transverse direction. The one or more projections 248 can rotate in a circular path about the second hinge axis 241 together with the one or more arms 230.

In some example configurations, the one or more projections 248 located on the one or more arms 230 can overlap with the one or more channels 219 located on the one or more legs 207. The one or more second torsion springs 247 can rotate the one or more arms 230 towards the one or more legs 207, and the one or more projections 248 can engage with the one or more channels 219 to put the stand assembly 200 in a locked configuration. In the locked configuration, the instantaneous leg angle 209 between the stand body 205 and the one or more legs 207 (shown in FIG. 3) can be fixed. The user of the display mounting apparatus 100 can rotate the handle assembly 208 towards the rear housing 11 of the electronic display 10 (shown in FIG. 1) to disengage the one or more projections 248 from the one or more channels 219 to put the stand assembly 200 in an unlocked configuration. In the unlocked configuration, the user of the display mounting apparatus 100 can adjust the instantaneous leg angle 209 between the stand body 205 and the one or more legs 207 to adjust an inclination angle 214 of the electronic display 10 relative to the work surface 105.

### Additional Notes and Aspects

Example 1 is a display mounting apparatus configured to be supported by a work surface, the apparatus comprising: a display interface couplable to an electronic display; a stand assembly connected to the display interface, the stand assembly adapted to receive the display interface; a clamp assembly couplable to the work surface; and a belt assembly connected to the stand assembly and the clamp assembly to retain the stand assembly at a desired distance from the clamp assembly along the work surface.

In Example 2, the subject matter of Example 1 optionally includes wherein the display mounting apparatus includes a secured configuration and an unsecured configuration, wherein, in the secured configuration, the display interface is securely attached to the stand assembly to hold the electronic display over the work surface, and wherein, in the unsecured configuration, the display interface is detachable from the stand assembly enabling removal of the electronic display from the display mounting apparatus.

In Example 3, the subject matter of Example 2 optionally includes wherein the stand assembly comprises: a stand body including a first face and a second face opposite the first face, the stand body elongated between a first portion and a second portion, the electronic display positionable across the first face of the stand body; a handle assembly coupled to the stand body proximate the second portion of the stand body; and one or more legs each including a proximal section rotatably coupled to the stand body at a first hinge proximate the second portion of the stand body, the one or more legs are locatable across the second face of the stand body, and the one or more legs adapted to rotate relative to the stand body about a first hinge axis defined by the first hinge to form an instantaneous leg angle between the one or more legs and the stand body.

In Example 4, the subject matter of Example 3 optionally includes wherein the first hinge further comprises one or more first torsion springs, wherein the one or more first torsion springs are concentric with the first hinge axis, wherein the one or more first torsion springs are coupled between the stand body and the one or more legs, and wherein the one or more first torsion springs are configured to bias the one or more legs toward the stand body.

In Example 5, the subject matter of Example 4 optionally includes wherein the stand assembly further comprises one or more first feet coupled to the stand body proximate the first portion of the stand body and one or more second feet coupled to the one or more legs proximate a distal section of the one or more legs, wherein the one or more first feet and the one or more second feet are configured to support the stand assembly over the work surface.

In Example 6, the subject matter of any one or more of Examples 4-5 optionally include wherein the handle assembly comprises: one or more connectors coupled to the stand body proximate the second portion; one or more arms having a first end and a second end opposite the first end; and a handle; wherein the one or more arms are rotatably coupled to the one or more connectors at a second hinge proximate the first end and the handle is coupled to the one or more arms proximate the second end, wherein the one or more arms are adapted to rotate relative to the stand body about a second hinge axis defined by the second hinge, wherein the handle assembly is operable to selectively put the stand assembly in a locked configuration where the instantaneous leg angle is fixed or in an unlocked configuration where the instantaneous leg angle is adjustable.

In Example 7, the subject matter of Example 6 optionally includes wherein the second hinge axis is parallel to the first hinge axis.

In Example 8, the subject matter of any one or more of Examples 6-7 optionally include wherein each leg of the one or more legs comprises a channel formed on an outer surface of the one or more legs proximate the proximal section.

In Example 9, the subject matter of Example 8 optionally includes wherein each arm of the one or more arms further comprises a projection formed on an outer surface of the one or more arms facing the one or more legs, wherein the projection extends from the one or more arms in a transverse direction, wherein the projection is configured to rotate together with the one or more arms in a circular path around the second hinge axis towards the one or more legs, and wherein the projection engages with the channel to put the stand assembly in the locked configuration and the projection disengages from the channel to put the stand assembly in the unlocked configuration.

In Example 10, the subject matter of Example 9 optionally includes wherein the second hinge further comprises one or more second torsion springs, wherein the one or more second torsion springs are concentric with the second hinge axis, wherein the one or more second torsion springs are coupled between the one or more connectors and the one or more arms, and wherein the one or more second torsion springs are configured to bias the one or more arms towards the one or more legs such that the projection is configured to engage with the channel to keep the stand assembly in the locked configuration.

In Example 11, the subject matter of Example 10 optionally includes wherein the display interface further comprises: an interface body including: a first end; and a second end opposite the first end; a flange formed on the first end of the interface body; a boss having a first cross-section formed on the second end of the interface body; and a rim having a second cross-section larger than the first cross-section formed on an end of the boss away from the interface body; wherein the flange is couplable to an electronic display via one or more mechanical fasteners.

In Example 12, the subject matter of Example 11 optionally includes wherein the stand body comprises an opening, the opening includes: a first section adapted to receive the rim of the display interface; and a second section adapted to receive the boss of the display interface; wherein the rim is configured to be inserted into the first section of the opening of the stand body, and the boss is configured to be inserted into the second section when the boss is inline with the stand body, wherein the stand body is at least partially located between the second end of the interface body and the rim.

In Example 13, the subject matter of Example 12 optionally includes wherein the stand assembly further comprises a retainer including: a stationary portion coupled to the stand body; and a flexible portion coupled to the stationary portion; wherein the flexible portion at least partially overlaps with the first portion of the opening, wherein the flexible portion includes a free state and a compressed state, wherein the rim of the display interface, when inserted in to the first portion of the opening of the stand body, contacts the flexible portion and deflects the flexible portion away from the stand body, and thereby, putting the flexible portion into the compressed state, and wherein the flexible portion is adapted to rebound to the free state when the boss of the display interface is inserted into the second portion of the opening and the contact is eliminated between the rim and the flexible portion, and thereby, trapping the display interface inside the second portion of the opening between the stand body and the flexible portion of the retainer to prevent removal of the display interface from the stand assembly.

In Example 14, the subject matter of any one or more of Examples 1-13 optionally include wherein the belt assembly comprises: a first portion coupled to one of the stand assembly or the clamp assembly on one end and coupled to a first clip on the other end, the first portion of the belt assembly having a first length; and a second portion coupled to the other one of the stand assembly or the clamp assembly on one end and coupled to a second clip on the other end, the second portion of the belt assembly having a second length;

wherein the first clip is removably coupled to the second clip to form the belt assembly, and wherein the first length and the second length together define the length of the belt assembly.

In Example 15, the subject matter of Example 14 optionally includes wherein the first length of the first portion of the belt assembly is adjustable enabling an adjustment of the length of the belt assembly to selectively position the stand assembly at a desired distance from the clamp assembly.

Each of these non-limiting examples can stand on its own or can be combined in any permutation or combination with any one or more of the other examples.

The above-detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

1. A display mounting apparatus configured to be supported by a work surface, the apparatus comprising:
a display interface couplable to an electronic display;
a stand assembly removably couplable to the display interface, the stand assembly adapted to receive at least a portion of the display interface, the stand assembly including a retainer selectively operable to limit or inhibit movement of the display interface with respect to the stand assembly;
a clamp assembly couplable to the work surface; and
a belt assembly connected to the stand assembly and the clamp assembly to limit or inhibit movement of the stand assembly from a desired distance from the clamp assembly along the work surface.

2. The display mounting apparatus of claim 1, wherein the retainer includes a secured configuration and an unsecured configuration, wherein, in the secured configuration, the display interface is attached to the
stand assembly to hold the electronic display over the work surface, and
wherein, in the unsecured configuration, the display interface is detachable from the stand assembly enabling removal of the electronic display from the display mounting apparatus.

3. The display mounting apparatus of claim 2, wherein the stand assembly includes:
a stand body including a first face and a second face opposite the first face, the stand body elongated between a first portion and a second portion, the electronic display positionable across the first face of the stand body;
a handle assembly couplable to the stand body proximate the second portion of the stand body; and
a leg including a proximal section rotatably couplable to the stand body at a first hinge proximate the second portion of the stand body, the leg are locatable across the second face of the stand body, the leg adapted to rotate relative to the stand body about a first hinge axis at least partially defined by the first hinge to form a leg angle between the leg and the stand body.

4. The display mounting apparatus of claim 3, wherein the first hinge includes a first torsion spring,
wherein the first torsion spring is concentric with the first hinge axis,
wherein the one or more first torsion are spring is coupled between the stand body and the leg, and
wherein the first torsion spring is configured to bias the leg toward the stand body.

5. The display mounting apparatus of claim 4, wherein the stand assembly includes a first foot couplable to the stand body proximate the first portion of the stand body and a second foot couplable to the leg proximate a distal section of the leg,
wherein the first foot and the second foot are configured to support the stand assembly over the work surface.

6. The display mounting apparatus of claim 4, wherein the handle assembly includes:
a connector coupled to the stand body proximate the second portion;
an arm having a first end and a second end opposite the first end; and
a handle;
wherein the arm is rotatably coupled to connector at a second hinge proximate the first end and the handle is coupled to the arm proximate the second end,
wherein the arm is adapted to rotate relative to the stand body about a second hinge axis at least partially defined by the second hinge,
wherein the handle assembly is operable to selectively put the stand assembly in a locked configuration where adjustment of the leg angle is limited or inhibited, or in an unlocked configuration where the leg angle is adjustable.

7. The display mounting apparatus of claim 6, wherein the second hinge axis is substantially parallel to the first hinge axis.

8. The display mounting apparatus of claim 6, wherein the leg includes a channel formed on an outer surface of the leg proximate the proximal section.

9. The display mounting apparatus of claim 8, wherein the arm further comprises a projection formed on an outer surface of arm facing the leg,
wherein the projection extends from the arm in a transverse direction,
wherein the projection is configured to rotate together with the arm in a curved path around the second hinge axis towards the leg, and
wherein the projection engages with the channel to put the stand assembly in the locked configuration and the projection disengages from the channel to put the stand assembly in the unlocked configuration.

10. The display mounting apparatus of claim 9, wherein the second hinge includes a second torsion spring,
wherein the second torsion spring is substantially concentric with the second hinge axis,
wherein the second torsion spring is coupled between the connector and the arm, and
wherein the second torsion spring is configured to bias the arm towards the leg such that the projection is
configured to engage with the channel to keep the stand assembly in the locked configuration.

11. The display mounting apparatus of claim 10, wherein the display interface includes:
an interface body including:
a first end; and
a second end opposite the first end;
a flange formed on the first end of the interface body;
a boss having a first cross-section formed on the second end of the interface body; and
a rim having a second cross-section larger than the first cross-section formed on an end of the boss away from the interface body;
wherein the flange is couplable to an electronic display via one or more mechanical fasteners.

12. The display mounting apparatus of claim 11, wherein the stand body includes an opening, the opening including:
a first section adapted to receive at least a portion of the rim of the display interface; and
a second section adapted to receive at least a portion of the boss of the display interface;
wherein the rim is insertable into the first section of the opening of the stand body, and the boss is insertable into the second section when the boss is inline with the stand body,
wherein the stand body is at least partially located between the second end of the interface body and the rim.

13. The display mounting apparatus of claim 12, wherein the retainer includes:
a stationary portion coupled to the stand body; and
a flexible portion coupled to the stationary portion; wherein the flexible portion at least partially overlaps with the first portion of the opening,
wherein the flexible portion includes a free state and a compressed state,
wherein the rim of the display interface, when inserted in to the first portion of the opening of the stand body, contacts the flexible portion and deflects the flexible portion away from the stand body, and thereby puts the flexible portion into the compressed state, and
wherein the flexible portion is adapted to rebound to the free state when the boss of the display interface is inserted into the second portion of the opening and the contact is eliminated between the rim and the flexible portion, and thereby traps the display interface inside the second portion of the opening between the stand body and the flexible portion of the retainer to limit or inhibit removal of the display interface from the stand assembly.

14. The display mounting apparatus of claim 1, wherein the belt assembly includes:
a first portion couplable to one of the stand assembly or the clamp assembly on a first end and couplable to a first clip on a second end, the first portion of the belt assembly having a first length; and
a second portion couplable to the other one of the stand assembly or the clamp assembly on a first end and couplable to a second clip on a second end, the second portion of the belt assembly having a second length;
wherein the first clip is removably couplable to the second clip to form the belt assembly, and
wherein the first length and the second length together define a length of the belt assembly.

15. The display mounting apparatus of claim 14, wherein the first length of the first portion of the belt assembly is adjustable, enabling an adjustment of the length of the belt assembly to selectively position the stand assembly at a desired distance from the clamp assembly.

16. The display mounting apparatus of claim 1, wherein:
the display interface includes a boss formed on the display interface; and
the stand assembly is adapted to receive at least a portion of the boss.

17. A display mounting apparatus comprising:
a display interface couplable to an electronic display;
a stand assembly selectively couplable to the display interface by receiving at least a portion of the display interface, the stand assembly including a resilient member configured to flex as the stand assembly receives a first display interface portion, the resilient member configured to rebound as the stand assembly receives a second display interface portion after the first display interface portion to limit or inhibit removal of the display interface from the stand assembly; and
an adjustable belt couplable between the stand assembly and a mounting surface, the adjustable belt configured to limit or inhibit movement of the stand assembly with respect to the mounting surface.

18. The display mounting apparatus of claim 17, wherein:
the display interface includes a protrusion having a variable cross section;
the first display interface portion includes a first portion of the protrusion having a first cross section; and
the second display interface portion includes a second portion of the protrusion having a second cross section smaller than the first cross section.

19. The display mounting apparatus of claim 17, wherein the display interface includes:
an interface body including:
a first end; and
a second end opposite the first end;
a flange formed on the first end of the interface body and couplable to the electronic display;
a boss having a first cross-section formed on the second end of the interface body; and
a rim having a second cross-section larger than the first cross-section formed on an end of the boss away from the interface body.

20. The display mounting apparatus of claim 19, wherein:
the stand assembly includes a stand body including a first face and a second face opposite the first face, the stand body elongated between a first portion and a second portion, the stand body including an aperture including:
a first section adapted to receive at least a portion of the rim; and
a second section adapted to receive at least a portion of the boss;
the rim is insertable into the first section of the aperture, and the boss is insertable into the second section of the aperture when the boss is inline with the stand body; and
the stand body is at least partially located between the second end of the interface body and the rim when the display interface and the stand assembly are coupled.
